(19) United States
(12) Patent Application Publication
(10) Pub. No.: US 2026/0006580 A1
(43) Pub. Date: Jan. 1, 2026

(54) Method and System for Roaming Based on Range Differentials

(71) Applicant: ZEBRA TECHNOLOGIES CORPORATION, LINCOLNSHIRE, IL (US)

(72) Inventors: Subramani Rajendiran, Bangalore (IN); Ohad Shatil, Dunwoody, GA (US)

(21) Appl. No.: 18/759,436

(22) Filed: Jun. 28, 2024

(51) Int. Cl. H04W 64/00; H04W 48/20; H04W 76/10

(52) U.S. Cl. CPC H04W 64/003; H04W 48/20; H04W 64/006; H04W 76/10

(57) ABSTRACT

A method in a communications device includes: establishing a connection with a base station; when an attribute of the connection satisfies an auxiliary trigger, obtaining: a first initial distance estimate to the base station; a second initial distance estimate to a candidate base station; determining: a first score for the base station, based on the first initial distance estimate; and a second score for the candidate base station, based on the second initial distance estimate; and when the attribute of the connection satisfies a roaming trigger, subsequent to satisfying the auxiliary trigger, selecting a connection target from the base station and the candidate base station, based on the first score and the second score.

### BACKGROUND

Roaming decisions can be made at a wireless communication device according to metrics such as received signal strength indicators (RSSI) and ranging information such as estimated distances between the device and access points. Signal strength indicators can be subject to transitory changes, and inaccurate distance estimations can result from multipath artifacts or other errors related to physical obstructions.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram of a wireless communications system.

FIG. 2 is a diagram of certain internal components of a communications device in the system of FIG. 1.

FIG. 3 is a flowchart of a method of roaming based on range differentials.

FIG. 4 is a diagram illustrating an example performance of blocks 305-320 of the method of FIG. 3.

FIG. 5 is a diagram illustrating an example performance of block 335 of the method of FIG. 3.

FIG. 6 is a diagram illustrating an example performance of block 340 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method in a communications device, the method including: establishing a connection with a base station; when an attribute of the connection satisfies an auxiliary trigger, obtaining: a first initial distance estimate to the base station; a second initial distance estimate to a candidate base station; determining: a first score for the base station, based on the first initial distance estimate; and a second score for the candidate base station, based on the second initial distance estimate; and when the attribute of the connection satisfies a roaming trigger, subsequent to satisfying the auxiliary trigger, selecting a connection target from the base station and the candidate base station, based on the first score and the second score.

Additional examples disclosed herein are directed to a communications device comprising: a communications interface; and a processor configured to: establish a connection with a base station; when an attribute of the connection satisfies an auxiliary trigger, obtain: a first initial distance estimate to the base station; a second initial distance estimate to a candidate base station; determine: a first score for the base station, based on the first initial distance estimate; and a second score for the candidate base station, based on the second initial distance estimate; and when the attribute of the connection satisfies a roaming trigger, subsequent to satisfying the auxiliary trigger, select a connection target from the base station and the candidate base station, based on the first score and the second score.

Further examples disclosed herein are directed to a method in a communications device, the method comprising: establishing a connection with a base station; when an attribute of the connection satisfies an auxiliary trigger, obtaining: a first initial range metric corresponding to the base station; a second initial range metric corresponding to a candidate base station; determining: a first score for the base station, based on the first initial range metric; and a second score for the candidate base station, based on the second initial range metric; and when the attribute of the connection satisfies a roaming trigger, subsequent to satisfying the auxiliary trigger, selecting a connection target from the base station and the candidate base station, based on the first score and the second score.

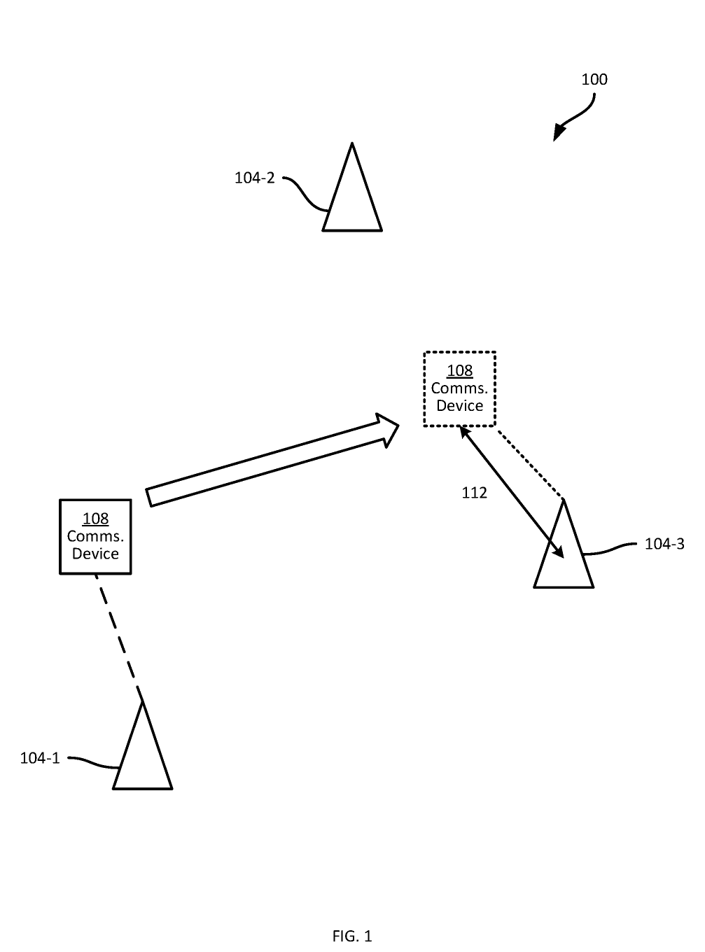

FIG. 1 illustrates a wireless communications system 100, including one or more wireless networks, such as wireless local area networks (WLANs) based on the Institute of Electrical and Electronics Engineers (IEEE) 802.11 family of standards (e.g., one or more Wi-Fi(TM) networks). In other embodiments, the system 100 can include one or more wide-area wireless networks (WWANs), such as cellular networks or the like, in addition to or instead of WLANs. As will be apparent in the discussion below, the functionality implemented in the system 100 can be applied to any of a variety of packet-switched wireless networks, including both local-area and wide-area networks. The system 100 can also include wired networks, e.g., interconnecting one or more of the wireless networks.

In the illustrated example, the system 100 includes a wireless network implemented by at least one base station, such as a wireless access point (AP) in the case of a WLAN. In the discussion below, the network is described as a WLAN, and the base stations are described as APs, but it will be understood that other forms of base station (e.g., gNB base stations in the context of cellular packet-switched networks).

The system 100 includes example access points 104-1, 104-2, and 104-3, which are referred to collectively as the access points 104, and generically as an access point 104. Similar nomenclature may also be used herein for other numbered components with hyphenated suffixes. The system 100 can include more than three access points 104, or fewer than three access points 104, in other examples. The access points 104 can implement a single WLAN, e.g., having a service set identifier SSID). In some examples, the access points 104 can be members of different WLANs (e.g., the APs 104-1 and 104-2 can be members of a given WLAN, and the AP 104-3 can be a member of another WLAN).

Each AP 104 can include an enclosure housing one or more controllers, transceivers, antenna assemblies, and the like. The APs 104 can be connected with a distribution subsystem (DS) or other infrastructure elements connecting the APs 104 to one another and/or to a wide area network.

Wireless communication devices, such as a wireless communication device 108 (also referred to herein as a client device 108), can establish wireless connections the APs 104 in order to communicate with the APs 104 and/or with other devices within the network and/or with other devices outside the network (e.g., via a gateway implemented by suitable network infrastructure). The system 100 can include more than one client device 108 in other examples. The client device(s) 108 of the system 100 can include any one or any suitable combination of mobile computers, smartphones, mobile printers, barcode scanners, tablet computers, or the like.

The client device 108 is mobile, and the physical location of the client device 108 relative to each of the APs 104 can therefore change over time. For example, in FIG. 1 the client device 108 is shown as being connected to the AP 104-1. The client device 108 may later be moved (e.g., transported by an operator of the device 108) to a different location, indicated in dashed lines in FIG. 1. The device 108 can be configured to assess the quality of the connection with the AP 104-1 and initiate a roaming operation if the connection quality satisfies a roam trigger. The roam trigger can be, for example, a received signal strength indicator (RSSI) corresponding to the AP 104-1 falling below a roaming threshold (e.g., -70 dBm, although a wide variety of other roaming thresholds can also be employed).

For example, when the device 108 reaches the new location, the RSSI corresponding to the AP 104-1 may fall below the roaming threshold, and the device 108 can perform a roaming operation that involves assessing various metrics corresponding to the AP 104-1 as well as other candidate APs 104 (e.g., the AP 104-2 and 104-3). In some configurations, the metrics assessed during a roaming operation include an RSSI value for each candidate AP 104 (e.g., including the AP 104-1 to which the device 108 is currently connected). Metrics assessed during a roaming operation can also include measurements of congestion, frequency band preferences of the device 108 and the APs 104, and the like. The device 108 can be configured to rank the APs 104, and select one of the APs as a roam target based on the ranking. As will be apparent, the roam target can include the AP 104-1, e.g., if the roaming assessment indicates that no other candidate APs 104 are likely to provide a sufficient improvement in connection quality over the AP 104-1. In the example illustrated in FIG. 1, the device 108 is shown having roamed from the AP 104-1 to the AP 104-3 at the new location.

In some systems, the client device 108 can also be configured to determine a range between the device 108 and a candidate AP 104, and to include the range in the above-mentioned assessment. For example, the device 108 can determine a range 112 between the device 108 and the AP 104-3, as well as corresponding ranges for the APs 104-1 and 104-2. For example, either or both of a greater range and a lower RSSI corresponding to a given AP 104 may reduce the likelihood of that AP 104 being selected as a roam target, while either or both of a smaller range and a higher RSSI corresponding to a given AP may increase the likelihood of that AP being selected as a roam target.

The roaming process set out above can lead to suboptimal roaming behavior under some conditions. For example, metrics such as RSSI may be subject to transitory changes due to physical obstructions in the environment of the device 108, electromagnetic interference, or the like. If the roaming operation coincides with such a transitory change, the ranking assigned to an AP 104 may not accurately represent the longer-term suitability of that AP 104. Other metrics, such as the range 112, can be subject to multipath artifacts resulting from physical obstructions in the environment of the device 108, which can inflate the perceived distance between an AP 104 and the device 108.

To mitigate the risk of suboptimal roaming decisions, the device 108 is configured to collect connection attributes prior to the detection of a roam trigger (e.g., before the RSSI with the AP 104 to which the device 108 is currently connected has fallen to the roam threshold mentioned above). As described in greater detail below, the device 108 is configured to obtain metrics such as an RSSI and a range from each candidate AP 104 in response to an attribute of the current connection (e.g., with the AP 104-1 in the FIG. 1) falling to an auxiliary threshold that is higher than the roam threshold. The device 108 is further configured to obtain a second set of those metrics from the candidate APs 104, e.g., in response to a roam trigger (although the device 108 can also obtain the second metrics in response to other events that precede the roam trigger). The device 108 is further configured to rank candidate APs 104 based on both the first and second metrics. For example, the device 108 can rank candidate APs 104 at least in part based on changes in the first and second range metrics captured as described above.

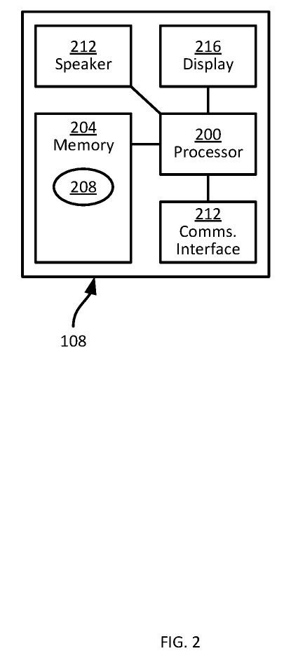

Prior to describing the roaming functionality implemented by the device 108 in detail, certain internal components of the device 108 are shown in FIG. 2. The device 108 includes a processor 200, such as a central processing unit (CPU), graphics processing unit (GPU), application-specific integrated circuit (ASIC), or the like, communicatively coupled with a non-transitory computer-readable storage medium such as a memory 204, e.g., a combination of volatile memory elements (e.g., random access memory (RAM)) and non-volatile memory elements (e.g., flash memory or the like). The memory 204 stores a plurality of computer-readable instructions in the form of applications, including in the illustrated example a communications application 208, whose execution by the processor 200 configures the device 108 to establish connections with the APs 104, perform roaming operations, and the like.

The device 108 also includes a communications interface 212, enabling the device 108 to establish connections with networks such as the network implemented by the APs 104. The communications interface 212 can therefore include any suitable combination of transceivers, antenna elements, and corresponding control hardware enabling communications with the APs 104. In some examples, the functionality implemented by the application 208 can be implemented within the communications interface 212, e.g., in the form of firmware instructions or the like stored at the interface 212 and executed by either or both of a dedicated controller of the interface 232 and the processor 200. The processor 200, memory 204, and communications interface 212 can be implemented as components of a system-on-chip (SoC) assembly, in some examples. The device 108 can also include input devices such as a touch screen, a microphone, a camera, or the like, and output devices such as a display 216, a speaker 220, and the like.

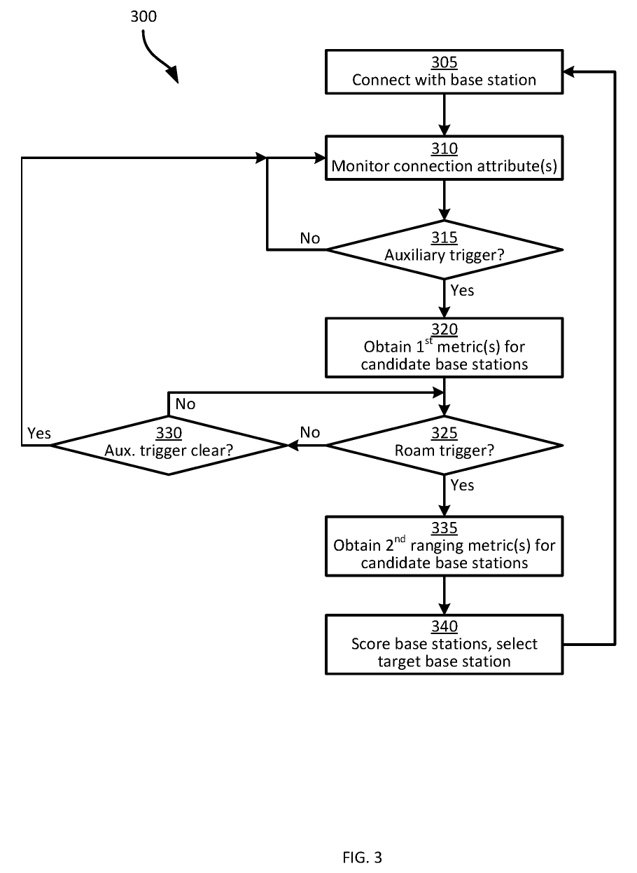

Turning to FIG. 3, a method 300 of roaming based on range differentials is illustrated. The method 300 is described below in conjunction with its performance by the device 108, for example via the execution of the application 208 by the processor 200 and/or a controller of the communications interface 212.

At block 305, the device 108 is configured to establish a connection with a base station, such as the AP 104-1 as shown in FIG. 1. The establishment of a connection with the base station 104 can be made in response to a previous roam operation, an initial connection when the device 108 is powered on or comes into range of the network implemented by the APs 104, or the like. Establishing a connection with an AP 104 at block 305 can be conducted according to any suitable communication standards, protocols, or the like, e.g., depending on the nature of the network implemented by the APs 104. Having established a connection with an AP 104, the device 108 can conduct any of a variety of communications with the AP 104 and/or with other devices via the AP 104, such as data transfer operations, web browsing, multimedia communications, and the like.

At block 310, the device 108 is configured to monitor, for example during the above-mentioned communications, at least one attribute of the connection established at block 305. The device 108 can, for example, monitor RSSI values associated with the base station 104-1 periodically. In some examples, RSSI values or other suitable signal strength indications for the AP 104-1 can be monitored by the device 108 substantially continuously (e.g., for each datagram received at the device 108 from the AP 104-1). At block 315, the device 108 is configured to determine whether the attribute monitored at block 310 satisfies an auxiliary trigger. Other examples of connection attributes can include packet loss rates and/or other suitable quality-of-service indications. For example, the device 108 can be configured to determine whether the most recently obtained value for the RSSI of the AP 104-1 falls below the auxiliary threshold mentioned above. The auxiliary threshold can be set at a predetermined distance from the roam threshold, e.g., 10 dB above the roam threshold. Thus, for example, if the roam threshold is -70 dBm, the auxiliary threshold can be set at -60 dBm. A wide variety of other auxiliary thresholds can be used in other examples, however.

When the determination at block 315 is negative, the device 108 can return to block 310, and continue monitoring the RSSI and/or other attributes associated with the AP 104-1 (e.g., while conducting communications with other devices via the AP 104-1). When the determination at block 315 is affirmative, the device 108 proceeds to block 320. At block 320, the device 108 is configured to obtain, for at least one AP 104, a first range metric (also referred to as an “initial” metric). The range metric obtained at block 320 is, in this example, an estimated distance between the device 108 and the corresponding AP 104. The range metrics can also include time-based measurements such as round-trip times, or other indicators of a distance between the device 108 and an AP 104. The performance of block 320 can include retrieving a list of candidate APs 104, such as one or more APs 104 identified an 802.11k / 802.11v neighbor report from the AP 104-1, to which the device 108 is currently connected. Use of a neighbor report, or identifiers of APs 104 obtained from another client device via a side channel in some examples, can mitigate time spent by the device 108 performing a roam scan. For example, the device 108 may omit a roam scan in some examples.

Obtaining the range metric from each candidate AP 104 (which can also include the currently connected AP 104) at block 320 can include initiating a message sequence with each candidate AP 104. For example, the device 108 can initiate a fine timing measurement (FTM) message sequence with each candidate AP 104. The sequence can include, for example, sending a first message from the device 108, addressed to a given AP 104 (in contrast to roam scan messages, which may be broadcast rather than specifically directed). The AP 104 is configured to respond, e.g., with a message indicating the time it received the first message, and the time it sent the response. The device 108 can then send one or more further messages, e.g., to repeat the above process one or more times, to exchange message timing information, or the like. The AP 104 and the device 108 can each be configured, using the timestamps from the above message sequence, to determine a physical distance between the AP 104 and the device 108 based on the round trip time indicated by those timestamps.

The device 108 can also obtain one or more additional metrics at block 320, for each candidate AP 104. The metrics obtained at block 320 are, in this example, obtained from the same sequence of messages used to generate the range metric. Examples of the metrics obtained at block 320, for a given AP 104, can include a received signal strength, e.g., determined as an average of received signal strength indicators determined for each message in the sequence received from the AP 104. The metrics determined at block 320 can also include a ranging success rate, for example indicated as a fraction of the messages in the sequence that were acknowledged by the AP 104. For example, if the message sequence (e.g., according to the FTM protocol) includes ten frames of data sent by the device 108 to a given AP 104, the success rate may include a number between zero and ten, corresponding to the number of frames that were acknowledged by the AP 104, without re-transmission. The success metric can also take a wide variety of other forms, in other implementations.

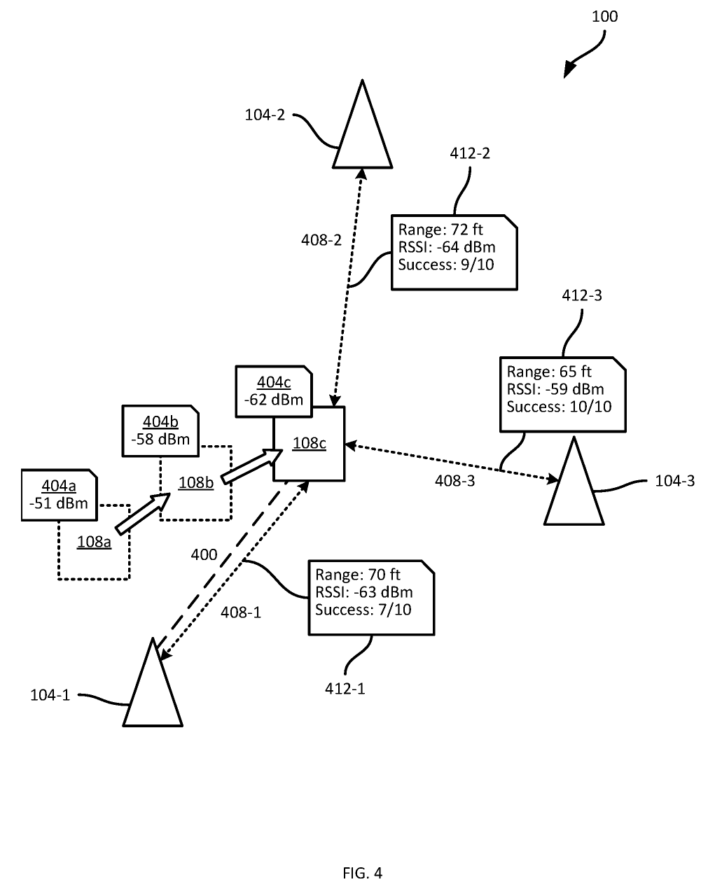

Turning to FIG. 4, example performances of blocks 305 to 320 are shown. For example, at a previous physical position 108a, the device 108 established a connection 400 with the AP 104-1. Each of the physical positions 108a, 108b, and 108c for the device 108 as shown in FIG. 4 are illustrated in association with an RSSI value corresponding to the AP 104-1, obtained at that position. As will be understood, the device 108 may also obtain additional connection attributes at intermediate positions not illustrated in FIG. 4.

At the position 108a, the device 108 determined an attribute 404a (e.g., an RSSI value, though other attributes can also be employed) of -51 dBm. At the position 108b, the attribute 404b is -58 dBm. The auxiliary threshold, in this example, is -60 dBm, and the determination at block 315 is therefore negative at the positions 108a and 108b. At the position 108c, the attribute 404c has a value of -62 dBm, which is below the auxiliary threshold, and the determination at block 315 is therefore affirmative.

At block 320, the device 108 obtains identifiers (e.g., media access control (MAC) addresses or the like) for each of the APs 104-1, 104-2, and 104-3, and initiates respective message sequences 408-1, 408-2, and 408-3 with the APs 104. The exchanges 408, as noted above, can each include a plurality of individual datagrams (e.g., frames whose format and content is defined by the FTM protocol, or another suitable ranging protocol). The device 108 obtains, based on the message sequences 408, first sets of metrics 412-1, 412-2, and 412-3, including at least a range metric, for the corresponding APs 104. As shown in FIG. 4, the range metrics 412 are expressed as distances in feet, though it will be understood that various other forms of distance measurement can be employed. Each set of metrics 412 also includes, in this example, an RSSI value derived from the corresponding sequence 408.

The RSSI value of each set of metrics 412 can be an average or other suitable aggregated value from RSSI values derived from individual frames during the corresponding message sequence 408. For example, if the sequence 408 involves receiving five frames at the device 108 from a given AP 104, the RSSI value in the corresponding set of metrics 412 can be an average of five individual RSSI values. The RSSI value of each set of metrics 412 may therefore be more accurate than a single RSSI measurement 404, as the aggregated values may mitigate the effects of transitory drops in signal strength. Each set of metrics 412 can also include a success rate derived from the corresponding sequence 408. The success rate can be expressed as a fraction of the messages in the sequence 408 that were acknowledged by the AP 104 without requiring retransmission. In other examples, the success rate can be supplemented or replaced with a packet loss metric, indicating how many packets in the sequences 408 were not acknowledge and/or required retransmission before being acknowledged.

After obtaining the first sets of metrics 412, as discussed above, the device 108 is configured to obtain a second set of metrics for each candidate AP 104. The second set of metrics can contain the same types of information as the metrics 412, and one or more of the values from a second set of metrics can therefore be compared to values of the same type in the metrics 412 as discussed below. In some examples, the second sets of metrics are obtained after the first set, and before a roam trigger occurs. For example, the device 108 can obtain the second sets of metrics when the signal strength associated with the current AP 104 falls below an intermediate threshold between the roam threshold and the auxiliary threshold. In other examples, the second sets of metrics are obtained after the first set, when a roam trigger occurs.

Referring again to FIG. 3, in this example implementation, at block 325 the device 108 is configured to determine whether a roam trigger has occurred. The roam trigger can include, for example, a determination that the signal strength associated with the AP 104-1 (to which the device 108 is currently connected) has fallen below a roaming threshold (e.g., -70 dBm). When the determination at block 325 is negative, as in connection with the scenario illustrated in FIG. 4, the device 108 proceeds to block 330. At block 330, the device 108 is configured to determine whether the auxiliary trigger has cleared (e.g., whether the signal strength associated with the current AP 104 has risen above the auxiliary threshold). When the determination at block 330 is negative, indicating that the auxiliary trigger persists, the device 108 can return to block 325.

When the determination at block 330 is affirmative, indicating that the auxiliary trigger has cleared, the device 108 can return to block 310 to continue monitoring one or more attributes of the connection 400. An affirmative determination at block 330 may indicate that the device 108 has returned closer to the AP 104, that a physical obstruction is no longer present, that a transitory drop in signal strength has resolved, or the like. The device 108 can also discard the metrics 412 following an affirmative determination at block 330, such that a subsequent auxiliary trigger initiates a new collection of metrics.

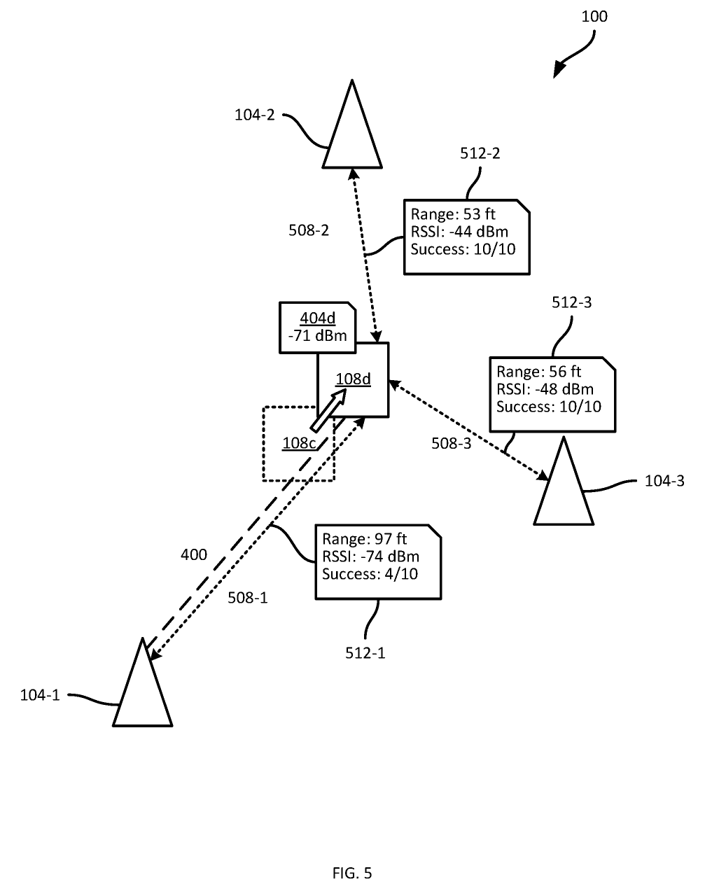

When the determination at block 325 is affirmative, the device 108 proceeds to block 335, and obtains second sets of metrics (also referred to as “current” metrics) for each of the candidate APs 104. Turning to FIG. 5, a further scenario is shown in which, a period of time after the scenario of FIG. 4, the device 108 has physically moved from the position 108c to a position 108d. The RSSI 404d associated with the AP 104-1 has decreased to -71 dBm, which in this example falls below the -70 dBm roam threshold. The determination at block 325 is therefore affirmative, and the device 108 proceeds to block 335.

At block 335, the device 108 initiates respective message sequences 508-1, 508-2, and 508-3 with the APs 104 and generates second sets of metrics 512-1, 512-2, and 512-3 corresponding to the APs 104-1, 104-2, and 104-3. The metrics 512, as with the metrics 412, include signal strength indicators, range metrics, and success rates in this example. At block 340, the device 108 is configured to score the APs 104 and select a roam target based on the scores. As will be apparent to those skilled in the art, the roam target can be the AP 104-1 itself, indicating a decision not to roam.

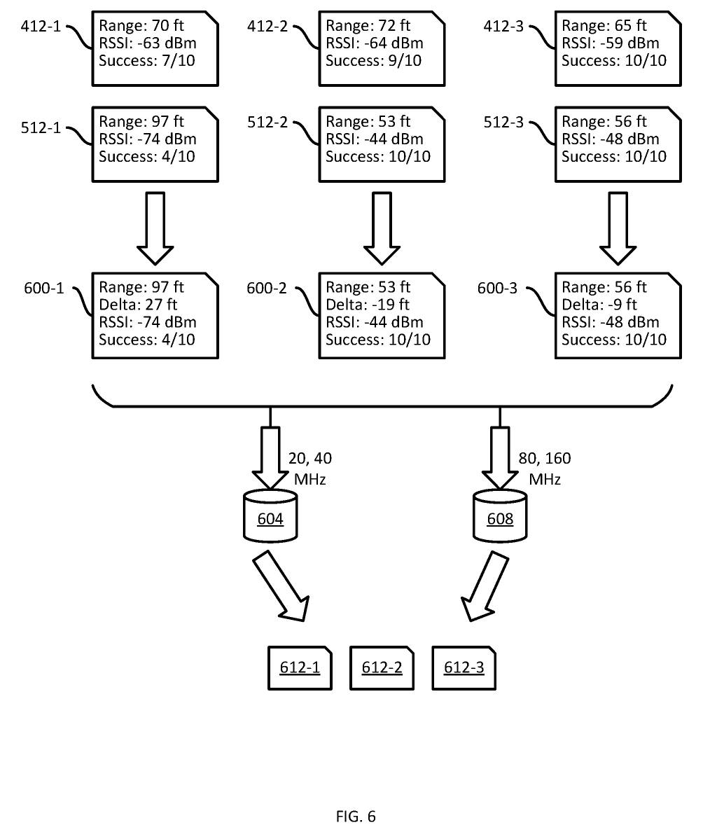

The determination of a score for a given AP 104 is based at least on the ranges from the first and second metrics 412 and 512 for that AP 104. The score can further be determined based on the other values in the set of metrics 512 (that is, the metrics obtained at block 335). Turning to FIG. 6, an example mechanism for determining scores for the APs 104 at block 340 is illustrated. In the illustrated example, the device 108 is configured to determine a difference between the range of the first metrics 412 and the range of the second metrics 512 for each AP 104. The range delta between ranges indicates whether the device 108 got closer to (negative delta) or further from (positive delta) the corresponding AP 104 between the times at which the metrics 412 and 512 were obtained.

The device 108 can be configured to generate a score for the APs 104 based on corresponding sets of values 600-1, 600-2, and 600-3, each including the above-mentioned delta, and the range, RSSI, and success rate metrics from the second metrics 512. In some examples, the device 108 can be configured to quantize the values 600. For example, the device 108 can maintain quantization parameters defining bins for each value, and corresponding score components for each bin. For instance, the range metrics can be quantized into bins with predefined boundary values (e.g., below 20 feet, between 20 and 40 feet, between 40 and 60 feet, between 60 and 80 feet, and above 80 feet). Each bin can be assigned a predetermined score component (e.g., 100, 80, 60, 40, and 20 respectively for the above bins). The number of bins, the boundary values, and the corresponding score components, can be varied in other implementations. Negative deltas can be assigned positive score components (indicating greater desirability as a roam target), and positive deltas can be assigned negative score components.

The values 600 for a given AP 104, or the quantized versions of those values, can then be combined to generate a score (e.g., a numerical value) for each AP 104. For example, each value (e.g., after quantization, if quantization is being used) can be modified by a weighting factor (e.g., a value between zero and one), and the resulting weighted score components can be combined to generate a score. In some examples, the weights applied to the score components (whether the values 600 themselves, or quantized values obtained therefrom) can depend on a channel bandwidth. For example, the device 108 can maintain a first set of weights 604, corresponding to certain channel bandwidths, and a second set of weights 608, corresponding to other channel bandwidths. The device 108 can select one or the other of the weights 604 or 608 for each AP 104, e.g., based on a preferred channel bandwidth communicated by the AP 104, determined from the neighbor list mentioned earlier, or the like.

In the example shown in FIG. 6, the weights 604 correspond to 20 MHz and 40 MHz channel bandwidths, and may place more weight on the RSSI and packet loss values, and less weight on the range and delta values. The weights 608 correspond to 80 MHz and 160 MHz channel bandwidths, and may place more weight on the range and delta values, and less weight on the RSSI and packet loss values. The device 108 can therefore generate scores 612-1, 612-2, and 612-3 for the APs 104-1, 104-2, and 104-3, respectively, using one or the other of the weights 604 and 608. In some examples, the device 108 can determine scores for each AP 104 using both weights 604 and 608, and the score 612 for each AP 104 can be a combination of the score resulting from the application of the weights 604, and the score resulting from the application of the weights 608. Based on the scores 612, the device 108 is configured to select a roam target, e.g., by selecting the AP 104 with the highest score, and initiating a connection with that AP 104.

Performance of the method 300 may improve the accuracy of roaming decisions at the device 108, e.g., reducing the likelihood of roaming to a suboptimal base station.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method in a communications device, the method comprising:
establishing a connection with a base station;
when an attribute of the connection satisfies an auxiliary trigger, obtaining:
a first initial distance estimate to the base station;
a second initial distance estimate to a candidate base station;
determining:
a first score for the base station, based on the first initial distance estimate; and
a second score for the candidate base station, based on the second initial distance estimate; and
when the attribute of the connection satisfies a roaming trigger, subsequent to satisfying the auxiliary trigger, selecting a connection target from the base station and the candidate base station, based on the first score and the second score.

2. The method of claim 1, further comprising: obtaining, subsequent to obtaining the initial distance estimates:
a first current distance estimate corresponding to the base station; and
a second current distance estimate corresponding to the candidate base station;
determining the first score based on the first initial distance estimate and the first current distance estimate; and
determining the second score based on the second initial distance estimate and the second current distance estimate.

3. The method of claim 1, wherein obtaining the initial distance estimates includes:
initiating a message sequence with each of the base station and the candidate base station, and
deriving the initial distance estimates from the message sequences.

4. The method of claim 3, wherein the message sequence includes a fine timing measurement message sequence.

5. The method of claim 3, further comprising:
obtaining, from each of the base station and a candidate base station based on the corresponding message sequence, a signal strength metric.

6. The method of claim 2, wherein the attribute of the connection includes a received signal strength;
wherein the attribute satisfies the auxiliary trigger when the received signal strength falls below an auxiliary threshold; and
wherein the attribute satisfies the roaming trigger when the received signal strength falls below a roaming threshold below the auxiliary threshold.

7. The method of claim 6, further comprising:
obtaining the current distance estimate from each of the base station and the candidate base station in response to the attribute satisfying one of:
(i) the roaming threshold, or
(ii) an intermediate threshold between the auxiliary threshold and the roaming threshold.

8. The method of claim 2, wherein determining the first score comprises:
determining a difference between the first initial distance estimate and the first current distance estimate; and
wherein determining the second score comprises determining a difference between the second initial distance estimate and the second current distance estimate.

9. The method of claim 1, wherein determining the first score comprises:
applying a weight to the first initial distance estimate, the weight selected based on a channel bandwidth corresponding to the base station or the candidate base station.

10. A communications device comprising:
a communications interface; and
a processor configured to:
establish a connection with a base station;
when an attribute of the connection satisfies an auxiliary trigger, obtain:
a first initial distance estimate to the base station;
a second initial distance estimate to a candidate base station;
determine:
a first score for the base station, based on the first initial distance estimate; and
a second score for the candidate base station, based on the second initial distance estimate; and
when the attribute of the connection satisfies a roaming trigger, subsequent to satisfying the auxiliary trigger, select a connection target from the base station and the candidate base station, based on the first score and the second score.

11. The communications device of claim 10, wherein the processor is further configured to:
obtain, subsequent to obtaining the initial distance estimates:
a first current distance estimate corresponding to the base station; and
a second current distance estimate corresponding to the candidate base station;
determine the first score based on the first initial distance estimate and the first current distance estimate; and
determine the second score based on the second initial distance estimate and the second current distance estimate.

12. The communications device of claim 10, wherein the processor is configured to obtain the initial distance estimates by:
initiating a message sequence with each of the base station and the candidate base station, and
deriving the initial distance estimates from the message sequences.

13. The communications device of claim 12, wherein the message sequence includes a fine timing measurement message sequence.

14. The communications device of claim 12, wherein the processor is configured to:
obtain, from each of the base station and a candidate base station based on the corresponding message sequence, a signal strength metric.

15. The communications device of claim 13, wherein the attribute of the connection includes a received signal strength;
wherein the attribute satisfies the auxiliary trigger when the received signal strength falls below an auxiliary threshold; and
wherein the attribute satisfies the roaming trigger when the received signal strength falls below a roaming threshold below the auxiliary threshold.

16. The communications device of claim 15, wherein the processor is configured to:
obtain the current distance estimate from each of the base station and the candidate base station in response to the attribute satisfying one of:
(i) the roaming threshold, or
(ii) an intermediate threshold between the auxiliary threshold and the roaming threshold.

17. The communications device of claim 11, wherein the processor is configured to determine the first score by:
determining a difference between the first initial distance estimate and the first current distance estimate; and
wherein determining the second score comprises determining a difference between the second initial distance estimate and the second current distance estimate.

18. The communications device of claim 10, wherein the processor is configured to determine the first score by:
applying a weight to the first initial distance estimate, the weight selected based on a channel bandwidth corresponding to the base station or the candidate base station.

19. A method in a communications device, the method comprising:
establishing a connection with a base station;
when an attribute of the connection satisfies an auxiliary trigger, obtaining:
a first initial range metric corresponding to the base station;
a second initial range metric corresponding to a candidate base station;
determining:
a first score for the base station, based on the first initial range metric; and
a second score for the candidate base station, based on the second initial range metric; and
when the attribute of the connection satisfies a roaming trigger, subsequent to satisfying the auxiliary trigger, selecting a connection target from the base station and the candidate base station, based on the first score and the second score.

20. The method of claim 19, wherein the initial range metrics include at least one of time-based values, or distance-based values.
